(19) United States
(12) Patent Application Publication
(10) Pub. No.: US 2011/0134162 A1
(43) Pub. Date: Jun. 9, 2011

(54) METHOD OF DRIVING ELECTROPHORETIC DISPLAY DEVICE, ELECTROPHORETIC DISPLAY DEVICE, AND ELECTRONIC EQUIPMENT

(75) Inventor: Yasushi YAMAZAKI, Azumino (JP)

(73) Assignee: SEIKO EPSON CORPORATION, Tokyo (JP)

(21) Appl. No.: 12/962,863

(22) Filed: Dec. 8, 2010

(30) Foreign Application Priority Data
Dec. 9, 2009 (JP) 2009-279838

(51) Int. Cl. G09G 5/10; G06F 3/038; G09G 3/34

(52) U.S. Cl. 345/690; 345/214; 345/107

(57) ABSTRACT

A method of driving an electrophoretic display device which includs a pair of substrates, an electrophoretic element disposed between the pair of substrates, and a display portion with a plurality of pixels arranged thereon, and has an electrode in which an image signal is input for each pixel, including a reset waveform input process in which, when a display image of the display portion is renewed from a first image to a second image, after displaying the first image and before displaying the second image, a prescribed image signal corresponding to an image different from the second image is input to the electrode.

### BACKGROUND

1. Technical Field

The present invention relates to method of driving an electrophoretic display device, an electrophoretic display device, and electronic equipment.

2. Related Art

In an electrophoretic display device, in order to prevent a decline in display performance due to non-equilibrium of a DC (direct current) hysteresis, there is known a device which is driven so that the waveform applied to a pixel maintains a state of equilibrium. For example, in JP-T-2008-509449, even when a base waveform is modified by the pause time dependence, an equilibrium pulse pair is added or deleted, so that the waveform applied to the pixel maintains an equilibrium state.

According to the invention described in JP-T-2008-509449, it is possible to maintain an equilibrium state of the current in each pixel. However, in a direct current drive (a polarity drive) display element such as an electrophoretic element, for example, in a case where the same image is repeatedly displayed or the like, pulses having different electric potentials are continuously input to adjacent signal lines, whereby corrosion occurs in a terminal connected to the signal line. That is, in the period when the same image is repeatedly displayed, a high level electric potential (e.g., 15V) is repeatedly input to a signal line connected to the pixel of a black display, and a low level electric potential (e.g., −15V) is repeatedly input to a signal line connected to the pixel of a white display. Then, since, for example, a high voltage of about 30V is continuously applied between the adjacent connection terminals, particularly, when the gap between the terminals is narrow or when the terminals are in a high temperature and high humidity situation, corrosion may occur in the connection terminals.

Furthermore, in an alternating current drive (an amplitude drive) display element such as a liquid crystal device, since an alternating current waveform is input to the signal line even when the same image is repeatedly displayed, such corrosion of the terminal does not occur.

### SUMMARY

An advantage of some aspects of the invention is to provide a method of driving an electrophoretic display device and an electrophoretic display device that has excellent reliability over a long period of time.

According to an aspect of the invention, there is provided a method of driving an electrophoretic display device which is formed by pinching an electrophoretic element between a pair of substrates and includes a display portion with a plurality of pixels arranged thereon, each pixel having an electrode in which an image signal is input, having a reset waveform input process in which, when a display image of the display portion is renewed from a first image to a second image, after displaying the first image and before displaying the second image, a reversal image signal in which the polarity of the image signal corresponding to the first image is reversed is input to the electrode.

In the driving method, in the reset waveform input process executed before displaying the second image, the waveform, in which the polarity of the input waveform used for displaying the first image is reversed, is input to the electrode. As a result, since the current hysteresis generated in an operation of displaying the first image can be reset by causing the current to flow in the reverse direction, it is possible to prevent corrosion of the connection terminal or the like due to the continuous flow of the current in a direction between the adjacent wirings or between the connection terminals. Thus, according to the aspect of the invention, it is possible to provide a driving method that can secure excellent reliability over a long period of time.

According to another aspect of the invention, there is provided a method of driving an electrophoretic display device which is formed by pinching an electrophoretic element between a pair of substrates and includes a display portion with a plurality of pixels arranged thereon, and each pixel having an electrode in which an image signal is input, having a reset waveform input process in which, when an image is displayed on the display portion, before an image signal corresponding to the image is input to the electrode, a reversal image signal, in which the polarity is reversed with respect to the image signal, is input to the electrode.

In the driving method, in the reset waveform input process that is executed before displaying the image, the waveform, in which the polarity of the input waveform used in an image display operation to be executed later is reversed, is input to the electrode. As a result, the current hysteresis is given in advance in the reset waveform input process, which makes it possible to offset the current hysteresis by the current generated in the later image display operation. Thus, it is possible to prevent corrosion of the connection terminal or the like due to the continuous flow of the current in a direction between the adjacent wirings or between the connection terminals, whereby excellent reliability can be secured over a long period of time.

According to still another aspect of the invention, there is provided a method of driving an electrophoretic display device which is formed by pinching an electrophoretic element between a pair of substrates and includes a display portion with a plurality of pixels arranged thereon, and each pixel having an electrode in which an image signal is input, having a reset waveform input process in which, when a display image of the display portion is renewed from a first image to a second image, after displaying the first image and before displaying the second image, a waveform which shifts the display portion to a single gradation is input to the electrode.

In the driving method, in the reset waveform input process that is executed before displaying the second image, the waveform, which shifts the display portion on which the first image is displayed to the single gradation, is input to the electrode. As a result, since the current hysteresis generated in the operation of displaying the first image can be reset by causing the current to flow in the reverse direction to that of the time when displaying the first image, it is possible to prevent corrosion of the connection terminal or the like due to the continuous flow of the current in a direction between the adjacent wirings or between the connection terminals. Thus, according to the aspect of the invention, it is possible to provide a driving method that can secure excellent reliability over a long period of time.

According to still another aspect of the invention, there is provided a method of driving an electrophoretic display device which is formed by pinching an electrophoretic element between a pair of substrates and includes a display portion with a plurality of pixels arranged thereon, and each pixel having an electrode in which an image signal is input, having a reset waveform input process in which, when the image is displayed on the display portion, before the image signal corresponding to the image is input to the electrode, a waveform, which shifts the display portion of the time when the image is displayed to a single gradation, is input to the electrode.

In the driving method, in the reset waveform input process that is executed before displaying the image, a waveform, which can shift the display portion after the image display operation to be executed later to the single gradation, is input to the electrode. As a result, the current hysteresis is given in advance in the reset waveform input progress, whereby the current hysteresis can be offset by the current that is generated in the next image display operation. Thus, it is possible to prevent corrosion of the connection terminal or the like due to the continuous flow of the current in a direction between the adjacent wirings or between the connection terminals, whereby excellent reliability can be secured over a long period of time.

It is also desirable to have an image erasing process of shifting all the pixels of the display portion to the same gradation after the reset waveform input process and before displaying the image on the display portion.

It is also desirable that the image erasing process includes a first image erasing process of shifting all the pixels of the display portion to a first gradation, and a second image erasing process of shifting all the pixels to a second gradation.

According to the driving method, it is possible to obtain a high quality of display in which afterimages are prevented.

According to still another aspect of the invention, there is provided an electrophoretic display device which is formed by pinching an electrophoretic element between a pair of substrates and includes a display portion with a plurality of pixels arranged thereon, and each pixel having an electrode in which an image signal is input and a control portion that drives and controls the pixel, wherein, when a display image of the display portion is renewed from a first image to a second image, after displaying the first image and before displaying the second image, the control portion executes a reset waveform input operation of inputting a reversal image signal in which the polarity of the image signal corresponding to the first image is reversed to the electrode.

According to the configuration, in the reset waveform input operation that is executed before displaying the second image, the waveform, in which the polarity of the input waveform used for displaying the first image is reversed, is input to the electrode. As a result, since the current hysteresis generated in an operation of displaying the first image can be reset by causing the current to flow in the reverse direction, it is possible to prevent corrosion of the connection terminal or the like due to the continuous flow of the current in a direction between the adjacent wirings or between the connection terminals. Thus, according to the aspect of the invention, it is possible to realize an electrophoretic display device that can secure excellent reliability over a long period of time.

According to still another aspect of the invention, there is provided an electrophoretic display device which is formed by pinching an electrophoretic element between a pair of substrates and includes a display portion with a plurality of pixels arranged thereon, and each pixel having an electrode in which an image signal is input and a control portion that drives and controls the pixel, wherein, when an image is displayed on the display portion, before an image signal corresponding to the image is input to the electrode, the control portion executes a reset waveform input operation of inputting a reversal image signal in which the polarity of the image signal is reversed to the electrode.

According to the configuration, in the reset waveform input operation that is executed before displaying the image, the waveform, in which the polarity of the input waveform used in an image display operation to be executed later is reversed, is input to the electrode. As a result, the current hysteresis is given in advance in the reset waveform input operation, which makes it possible to offset the current hysteresis by the current generated in the later image display operation. Thus, it is possible to prevent corrosion of the connection terminal or the like due to the continuous flow of the current in a direction between the adjacent wirings or between the connection terminals, whereby excellent reliability can be secured over a long period of time.

According to still another aspect of the invention, there is provided an electrophoretic display device which is formed by pinching an electrophoretic element between a pair of substrates and includes a display portion with a plurality of pixels arranged thereon, and each pixel having an electrode in which an image signal is input and a control portion that drives and controls the pixel, wherein, when a display image of the display portion is renewed from a first image to a second image, after displaying the first image and before displaying the second image, the control portion executes a reset waveform input operation of inputting a waveform, which shifts the display portion to a single gradation, to the electrode.

According to the configuration, in the reset waveform input operation that is executed before displaying the second image, the waveform, which shifts the display portion on which the first image is displayed to the single gradation, is input to the electrode. As a result, since the current hysteresis generated in the operation of displaying the first image can be reset by causing the current to flow in the reverse direction to that of the time when displaying the first image, it is possible to prevent corrosion of the connection terminal or the like due to the continuous flow of the current in a direction between the adjacent wirings or between the connection terminals. Thus, according to the aspect of the invention, it is possible to provide a driving method that can secure excellent reliability over a long period of time.

According to still another aspect of the invention, there is provided an electrophoretic display device which is formed by pinching an electrophoretic element between a pair of substrates and includes a display portion with a plurality of pixels arranged thereon, and each pixel having an electrode in which an image signal is input and a control portion that drives and controls the pixel, wherein, when the image is displayed on the display portion, before the image signal corresponding to the image is input to the electrode, the control portion executes a reset waveform input operation of inputting a waveform, which shifts the display portion to a single gradation, to the electrode.

According to the configuration, in the reset waveform input operation that is executed before displaying the image, a waveform, which can shift the display portion after the image display operation to be executed later to the single gradation, is input to the electrode. As a result, the current hysteresis is given in advance in the reset waveform input operation, whereby the current hysteresis can be offset by the current generated in the next image display operation. Thus, it is possible to prevent corrosion of the connection terminal or the like due to the continuous flow of the current in a direction between the adjacent wirings or between the connection terminals, whereby excellent reliability can be secured over a long period of time.

It is also desirable that the control portion executes an image erasing operation of shifting all the pixels to the same gradation after the reset waveform input operation and before the operation of displaying the image on the display portion.

It is also desirable that the image erasing operation includes a first image erasing operation of shifting all the pixels of the display portion to a first gradation, and a second image erasing operation of shifting all the pixels to a second gradation.

According to the configuration, it is possible to obtain a high quality of display in which afterimages are prevented.

Electronic equipment according to still another aspect of the invention includes the electrophoretic display device mentioned above.

According to the configuration, it is possible to provide electronic equipment including a display unit having excellent reliability.

### BRIEF DESCRIPTION OF THE DRAWINGS

The invention will be described with reference to the accompanying drawings, wherein like numbers reference like elements.

FIG. 1 is a schematic configuration diagram of an electrophoretic display device according to a first embodiment.

FIG. 2 is a diagram showing a pixel circuit.

FIGS. 3A to 3C are a principal part cross-sectional view and an operation explanation diagram of an electrophoretic display device according to the embodiment.

FIGS. 4A and 4B are diagrams showing the overall configuration of an electrophoretic display device according to the embodiment.

FIG. 5 is a diagram showing a specific example of a pixel circuit.

FIGS. 6A and 6B are diagrams showing specific examples of a terminal forming area.

FIGS. 7A and 7B are cross-sectional views corresponding to FIGS. 5, 6A and 6B.

FIGS. 8A and 8B are explanation diagrams relating to a method of driving an electrophoretic display device according to the embodiment.

FIG. 9 is a timing chart of a method of driving an electrophoretic display device according to the embodiment.

FIGS. 10A and 10B are explanation diagrams showing another form of the driving method.

FIG. 11 is a timing chart relating to a driving method of a second embodiment.

FIG. 12 is a timing chart relating to a driving method of a third embodiment.

FIG. 13 is a diagram showing an example of electronic equipment.

FIG. 14 is a diagram showing an example of electronic equipment.

FIG. 15 is a diagram showing an example of electronic equipment.

### DESCRIPTION OF EXEMPLARY EMBODIMENTS

Hereinafter, embodiments of the invention will be described with reference to the drawings.

In addition, the scope of the invention is not limited to the following embodiments but can be arbitrarily changed within the scope of the technical idea of the invention. Furthermore, in the following drawings, in order to make each configuration easier to understand, the scales, the numbers or the like in of the actual structure and each structure are set differently in some cases.

### First Embodiment

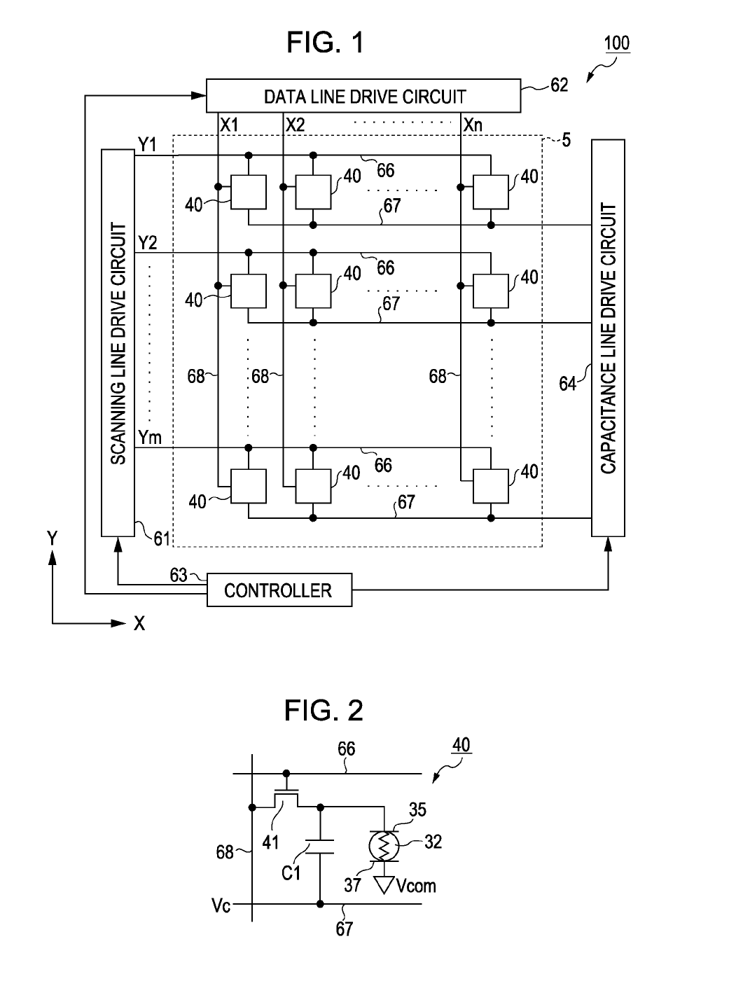

FIG. 1 is a schematic configuration diagram of an electrophoretic display device 100 that is an embodiment of the invention.

The electrophoretic display device 100 includes a display portion 5 in which a plurality of pixel 40 is arranged in the shape of a matrix. Around the display portion 5, a scanning line drive circuit 61, a data line drive circuit 62, a controller (a control portion) 63, and a capacitance line drive circuit 64 are disposed. The scanning line drive circuit 61, the data line drive circuit 62, and the capacitance line drive circuit 64 are connected to the controller 63, respectively. The controller 63 synthetically controls them based on the image data or the synchronization signal that is supplied from the upper device.

In the display portion 5, a plurality of scanning lines 66 extending from the scanning line drive circuit 61 and a plurality of data lines 68 extending from the data line drive circuit 62 are formed, and pixel 40 are provided to correspond to the intersecting position. Furthermore, capacitance lines 67 extending from the capacitance line drive circuit 64 are provided and each wiring is connected to the pixel 40.

The scanning line drive circuit 61 is connected to each of the pixel 40 via m scanning lines 66 (Y1, Y2, . . . Ym), selects the scanning lines 66 from the first row to m-th row one by one under the control of the controller 63, and supplies the selection signal, which regulates the on timing of a selection transistor 41 (see FIG. 2) provided in the pixel 40, via the selected scanning line 66. The data line drive circuit 62 is connected to each of the pixel 40 via n data lines 68 (X1, X2, . . . , Xn), and supplies an image signal, which regulates the pixel data corresponding to each of the pixel 40, to the pixel 40 under the control of the controller 63. The capacitance line drive circuit 64 supplies a predetermined electric potential to the capacitance lines 67 under the control of the controller 63.

FIG. 2 is a circuit configuration diagram of the pixel 40.

In the pixel 40, the selection transistor 41, a maintenance resistance C1, a pixel electrode 35, an electrophoretic element 32, and a common electrode 37 are provided. Moreover, the scanning line 66, the data line 68 and the capacitance line 67 are connected to the pixel 40. The scanning line 66 is connected to a gate of the selection transistor 41, the data line 68 is connected to a source, and the pixel electrode 35 and one electrode of the maintenance capacitance C1 are connected to a drain. The other electrode of the maintenance capacitance C1 is connected to the capacitance line 67.

Furthermore, in the case of the present embodiment, the selection transistor 41 is an N-MOS (Negative Channel Metal Oxide Semiconductor) transistor but may be replaced with another type of switching element having the same function as the N-MOS transistor. For example, a P-MOS transistor may be used in place of the N-MOS transistor, and an inverter or a transmission gate may be used.

In the pixel 40, when the selection transistor 41 enters an on state by the selection signal that is input via the scanning line 66, the image signal is input from the data line 68 to the pixel electrode 35 via the selection transistor 41 and the maintenance capacitance C1 is charged. In addition, the pixel electrode 35 is maintained at a predetermined electric potential level by energy accumulated in the maintenance capacitance C1, and the electrophoretic element 32 is driven by the electric potential difference between the pixel electrode 35 and the common electrode 37.

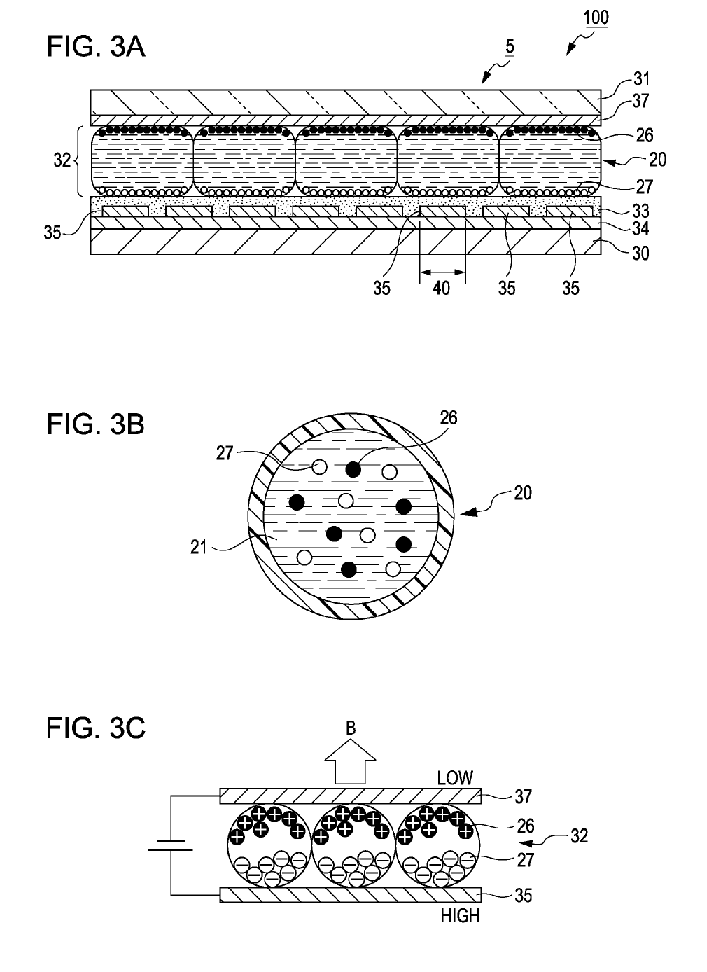

Next, FIG. 3A is a partial cross-sectional view of an electrophoretic display device 100 in the display portion 5. The electrophoretic display device 100 includes a configuration in which the electrophoresis element 32 with a plurality of microcapsules 20 arranged thereon is pinched between an element substrate (a first substrate) 30 and an opposed substrate (a second substrate) 31.

In the display portion 5, at the electrophoretic element 32 side of the element substrate 30, a circuit layer 34 on which the scanning line 66, the data line 68, the selection transistor 41 or the like shown in FIG. 1 or 2 are formed is provided, and a plurality of pixel electrodes 35 is arranged and formed on the circuit layers 34.

The element substrate 30 is a substrate formed of glass, plastic or the like, and is disposed at the opposite side of the image display surface and thus may not be transparent. The pixel electrode 35 is an electrode in which nickel plating and gold plating are stacked on Cu (copper) foil in this order, or is an electrode that applies the voltage to the electrophoretic element 32 formed by Al (aluminum), ITO (indium and tin oxide) or the like.

On the other hand, at the electrophoretic element 32 side of the opposed substrate 31, a plane-shaped common electrode 37 facing the plurality of pixel electrodes 35 is formed, and the electrophoretic element 32 is provided on the common electrode 37.

The opposed substrate 31 is a substrate formed of glass, plastic or the like, and is disposed at the image display side and thus becomes a transparent substrate. The common electrode 37 is an electrode that applies the voltage to the electrophoretic element 32 together with the pixel electrode 35, and is a transparent electrode formed of MgAg (magnesium silver), ITO (indium and tin oxide), IZO (indium zinc oxide) or the like.

In addition, the electrophoretic element 32 and the pixel electrode 35 are bonded to each other via the adhesive layer 33, whereby the element substrate 30 and the opposed substrate 31 are joined to each other.

Furthermore, generally, the electrophoretic element 32 is formed at the opposed substrate 31 side in advance and treated as an electrophoretic sheet including the adhesive layer 33. In the production process, the electrophoretic sheet is treated in the state in which a protective release sheet is adhered to the surface of the adhesive layer 33. In addition, the electrophoretic sheet in which the release sheet is peeled off is adhered with respect to the separately produced element substrate 30 (on which the pixel electrode 35, various circuits or the like are formed), thereby forming the display portion 5. For this reason, the adhesive layer 33 exists only at the pixel electrode 35 side.

FIG. 3B is a schematic cross-sectional view of the micro capsule 20. The micro capsule 20 has, for example, a particle diameter of about 50 μm and is a spherical body in which a dispersion medium 21, a plurality of white particles (electrophoretic particles) 27, and a plurality of black particles (electrophoretic particles) 26 are encapsulated. As shown in FIG. 3A, the micro capsule 20 is pinched between the common electrode 37 and the pixel electrode 35, and one or a plurality of micro capsules 20 is disposed within one pixel 40.

An outer shell portion (a wall film) of the micro capsule 20 is formed using acrylic resin such as polymethylmethacrylate and polyethylmethacrylate urea resin, polymer resin having translucency such as gum Arabic or the like.

The dispersion medium 21 is a liquid that disperses the white particle 27 and the black particle 26 into the micro capsule 20. The dispersion medium 21 can include water, alcohol-based solvent (methanol, ethanol, isopropanol, butanol, octanol, methyl cellusolve or the like), esters (ethyl acetate, butyl acetate or the like), ketones (acetone, methyl ethyl ketone, methyl isobutyl ketone or the like), aliphatic hydrocarbons (pentane, hexane, octane or the like), alicyclic hydrocarbons (cyclohexane, methyl cyclohexane or the like), aromatic hydrocarbons (benzene, toluene, and benzenes having a long chain alkyl group (xylene, hexyl benzene, heptyl benzene, octyl benzene, nonyl benzene, decyl benzene, undecyl benzene, dodecyl benzene, tridecyl benzene, tetradecyl benzene or the like)), halogenated hydrocarbons (chloromethylene, chloroform, carbon tetrachloride, 1,2-dichloroethane or the like), carboxylic acid salts or the like, and other oils may be used. These materials can be used alone or a mixture thereof, a surfactant or the like may be mixed.

The white particle 27 is a particle (polymer or colloid) formed of white pigment such as titanium dioxide, zinc oxide, and antimony trioxide and is used for example by being negatively charged. The black particle 26 is a particle (polymer or colloid), for example, formed of black pigment such as aniline black and carbon black and is used, for example, by being positively charged.

An electrolyte, a surfactant, a metallic soap, resin, rubber, oil, varnish, a charge control agent formed of particles such as a compound, a dispersion agent such as a titanium-based coupling agent, an aluminum-based coupling agent and a silane-based coupling agent, a lubricant agent, a stabilizer or the like can be added to the pigments as occasion demands.

Furthermore, instead of the black particle 26 and the white particle 27, for example, pigments such as red, green, blue, yellow, cyan and magenta may be used. According to this configuration, red, green, blue, yellow, cyan, magenta or the like can be displayed on the display portion 5.

FIG. 3C is an operation explanation diagram of the electrophoretic element and shows a case of indicating the pixel 40 in black.

In the case of displaying the pixel 40 in black, as shown, the common electrode 37 is maintained at a relatively low electric potential, and the pixel electrode 35 is maintained at a relatively high electric potential. That is, upon setting the electric potential of the common electrode 37 as a standard electric potential, the pixel electrode 35 is maintained at a positive polarity. As a result, the black particle 26 which is positively charged is attracted to the common electrode 37, on the other hand, the white particle 27 which is negatively charged is attracted to the pixel electrode 35. As a consequence, black is recognized when the pixel is viewed from the common electrode side 37.

In the case of displaying the pixel 40 in white, the common electrode 37 is maintained at a relatively high electric potential, the pixel electrode 35 is maintained at a relatively low electric potential, and the pixel electrode 35 is set as the negative polarity with respect to the electric potential of the common electrode 37. As a result, the white particle 27 which is negatively charged is attracted to the common electrode 37 side, and white is recognized when viewed from the display surface side.

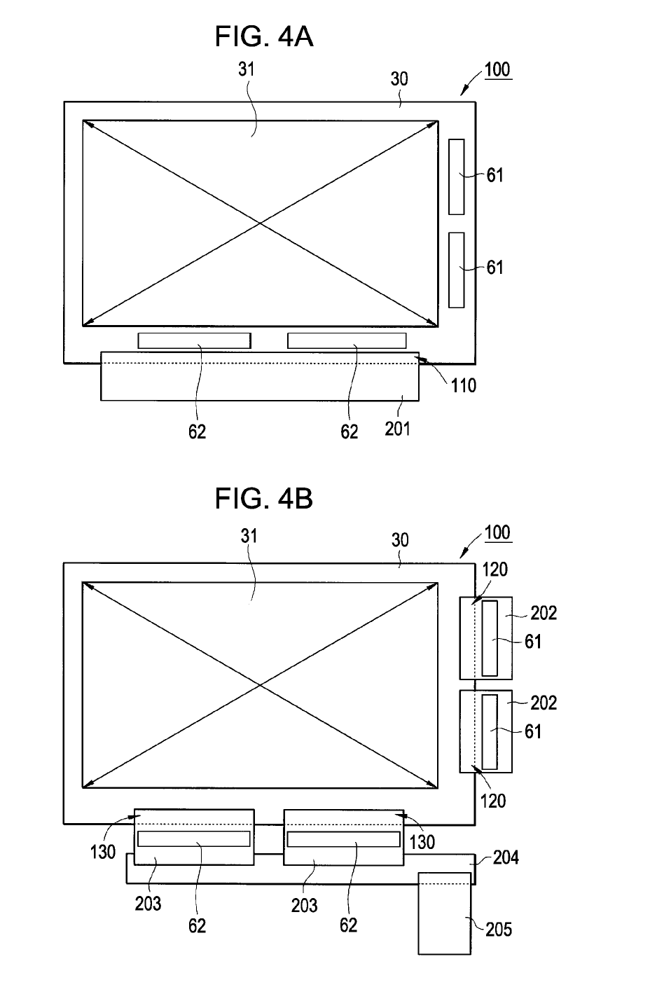

FIGS. 4A and 4B are diagrams showing a plurality of examples of the overall configuration of the electrophoretic display device 100.

In an example shown in FIG. 4A, the element substrate 30 has a plane size greater than that of the opposed substrate 31 that is an electrophoretic sheet, and, on the element substrate 30 extending to the outside from the opposed substrate 31, two scanning line drive circuits 61 and two data line drive circuits 62 are installed via a COG (Chip On Glass). Moreover, a terminal forming area 110 is formed in an edge in the vicinity of the data line drive circuit 62, and a flexible substrate 201 for connecting to external equipment is bonded to the terminal forming area 110 via an ACP (anisotropy conductive paste) or an ACF (anisotropy conductive film).

In the example shown in FIG. 4A, the display portion 5 is formed in an area where the element substrate 30 overlaps with the opposed substrate 31, and a wiring (the scanning line 66 or the data line 68) extending from the display portion 5 extends to an area where the scanning line drive circuit 61 and the data line drive circuit 62 are installed and is connected to a connection terminal formed in the installation area. In addition, the scanning line drive circuit 61 or the data line drive circuit 62 is installed with respect to the connection terminal via the ACP or the ACF.

On the other hand, in the example shown in FIG. 4B, the scanning line drive circuit 61 and the data line drive circuit 62 are not installed on the element substrate 30, but installed on the flexible substrates 202 and 203 via a COF (Chip On Film) (or a TAB (Tape Automated Bonding)). In addition, the flexible substrate 202 with the scanning line drive circuit 61 installed thereon is installed on a terminal forming area 120 formed in an edge portion along a short side of the element substrate 30 via the ACP or the like. Furthermore, the flexible substrate 203 with the data line drive circuit 62 installed thereon is installed on a terminal forming area 130 formed in an edge portion along a long side of the element substrate 30 via the ACP or the like. A plurality of connection terminals is formed in the terminal forming areas 120 and 130, respectively, and the scanning line 66 or the data line 68 extending from the display portion 5 is connected to each of the connection terminals.

In addition, the flexible substrate 203 with the data line drive circuit 62 installed thereon is also connected to a rigid substrate 204 and an external connection flexible substrate 205 is connected to the rigid substrate 204.

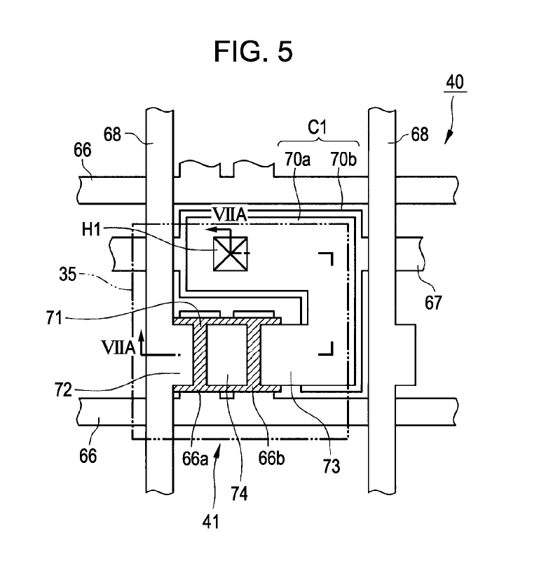

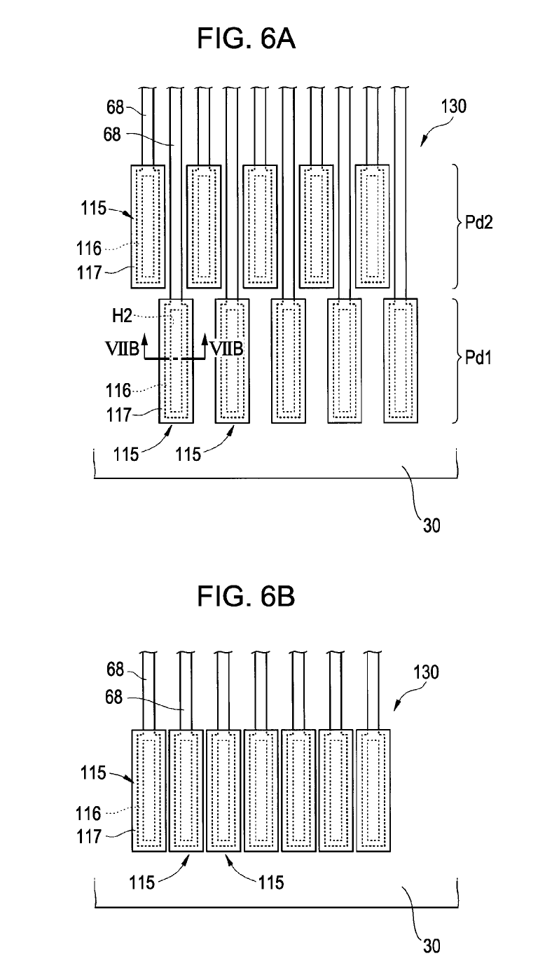

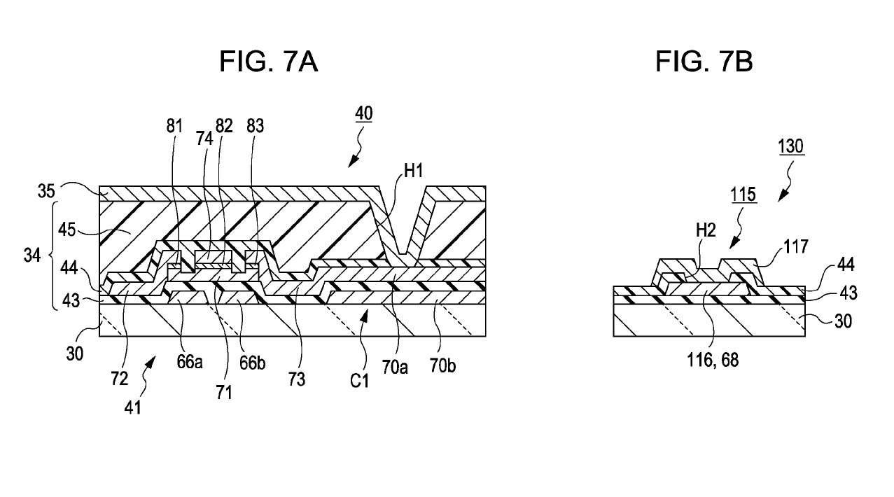

Next, FIG. 5 is a diagram showing a specific configuration example of the pixel 40 on the element substrate 30. FIGS. 6A and 6B are plane views showing two configuration examples of the terminal forming area 130 shown in FIG. 4B. FIGS. 7A and 7B are cross-sectional views corresponding to FIGS. 5, 6A and 6B.

Firstly, as shown in FIG. 5, in the pixel forming area on the element substrate 30, a plurality of scanning lines 66 and a plurality of data lines 68 extending in a direction intersecting with each other are formed. In FIG. 5, an area having a rectangular shape when viewed from the plane, which is surrounded by two adjacent scanning lines 66 and two adjacent data lines 68, substantially corresponds to the plane area of the pixel 40.

In the pixel 40, a pixel electrode 35 having approximately a rectangular shape when viewed from the plane, which has a two-layered structure in which a metallic material such as Al (aluminum) having the light shielding property or a transparent conductive material such as ITO (indium tin oxide) or the metallic material and the transparent conductive material are stacked in this order, the maintenance capacitance C1, and the selection transistor 41 are formed.

The selection transistor 41 includes a semiconductor layer 71 formed of amorphous silicon (a-Si), gate electrodes 66a and 66b provided at the lower layer side (the element substrate 30 side) of the semiconductor layer 71, a source electrode 72 installed at the upper layer side of the semiconductor layer 71, a drain electrode 73, and a connection electrode 74.

The gate electrodes 66a and 66b are formed by dividing a part of the scanning lines 66 in the direction along the data line 68. The semiconductor layer 71 having a rectangular shape when viewed from the plane is formed so as to overlap with the gate electrodes 66a and 66b. The source electrode 72 is formed by dividing a part of the data line 68 in the direction along the scanning line 66 and is connected to the semiconductor layer 71 (the source area) via an ohmic contact layer 81 formed of a doped silicon film. One end portion of the drain electrode 73 is connected to the semiconductor layer 71 (the drain area) via an ohmic contact layer 83 formed of a doped silicon film, and the other end thereof is connected to the capacitance electrode 70a. The connection electrode 74 having a rectangular shape, which is formed between the gate electrodes 66a and 66b and is connected to the semiconductor later 72 via the ohmic contact layer 82 connects transistors that are formed to correspond to the respective gate electrodes 66a and 66b.

The maintenance capacitance C1 is a capacitance element that includes capacitance electrodes 70a and 70b having an approximately L shape when viewed from the plane which is formed within the pixel area, and an insulation film (a gate insulation film) formed therebetween. The capacitance electrode 70a is connected to the drain electrode 73 of the selection transistor 41 and is connected to the pixel electrode 35 via a contact hole H1. The capacitance electrode 70b is connected to the capacitance line 67 extending in parallel to the scanning line 66.

In the pixel 40 having the above-mentioned configuration, the selection transistor 41 enters an on state only for a predetermined period using the selection signal that is input from the scanning line 66, and the image signal to be supplied from the data line 68 is written on the pixel electrode 35.

With reference to the cross-section structure shown in FIGS. 7A and 7B, the gate electrodes 66a and 66b and the capacitance electrode 70b are formed on the element substrate 30. A gate insulation film 43 is formed so as to cover the gate electrodes 66a and 66b and the capacitance electrode 70b. The semiconductor layer 71 is formed on the gate insulation film 43 situated on the gate electrodes 66a and 66b, and on the gate insulation film 43 including a partial area on the semiconductor layer 71, the source electrode 72, the drain electrode 73, the connection electrode 74, and the capacitance electrode 70a are formed. A passivation film 44 is formed so as to cover the selection transistor 41 and the maintenance capacitance C1 formed by the constituents. A planarization film 45 is formed on the passivation film 44 and the pixel electrode 35 is formed on the planarization film 45. The pixel electrode 35 is connected to the capacitance electrode 70a via the contact hole H1 that passes through the planarization film 45 and the passivation film 44 and reaches the capacitance electrode 70a.

Next, in the terminal forming area 130 shown in FIG. 6A, a plurality of connection terminals 115 is arranged along an edge of the element substrate 30 extending in the left and right directions as shown. The data line 68 extending from the display portion 5 is connected to each of the connection terminals 115. More specifically, the connection terminal 115 includes a lower layer electrode 116 including a wide flange region formed in the front end portion of the data line 68, and an upper layer electrode 117 formed on the lower layer electrode 116. The lower layer electrode 116 and the upper layer electrode 117 are connected to each other via a contact hole H2 formed within the plane area of the lower layer electrode 116.

The connection terminal 115 is arranged in the arrangement direction (the left and right direction as shown) in a zigzag manner, and the data line 68 connected to a first terminal row Pd1 at a side adjacent to the substrate end edge extends to the display portion 5 via the portion between the connection terminals 115 of a second terminal row Pd2 at a side adjacent to the display portion 5. In this manner, the connection terminals 115 are arranged on the terminal forming area 130 with a high density.

Upon seeing the cross-sectional structure shown in FIGS. 7A and 7B, the gate insulation film 43 is formed on the element substrate 30 and the lower layer electrode 116 is formed on the gate insulation film 43. The passivation film 44 is formed so as to cover the lower layer electrode 116 and the upper layer electrode 117 formed of the same material as the pixel electrode 35 is formed on the passivation film 44. The upper layer electrode 117 and the lower layer electrode 116 are connected to each other via the contact hole H2 that passes through the passivation film 44 and reaches the lower layer electrode 116.

Furthermore, the configuration of the terminal forming area 130 may be a form in which the connection terminals 115 are arranged along the peripheral edge of the element substrate 30 in a line, as shown in FIG. 6B. In this case, when the connection terminals 115 are disposed at a high density, since the upper layer electrode 117 exposed to the surface of the element substrate 30 reaches an adjacent position, when a high electric potential difference occurs in the adjacent connection terminals 115, corrosion due to the current flowing via the ACP or the like easily occurs.

### Driving Method

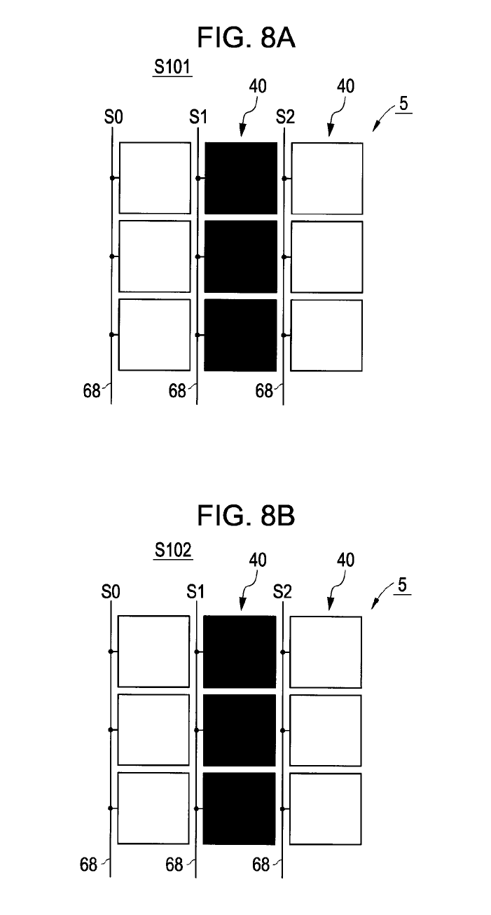

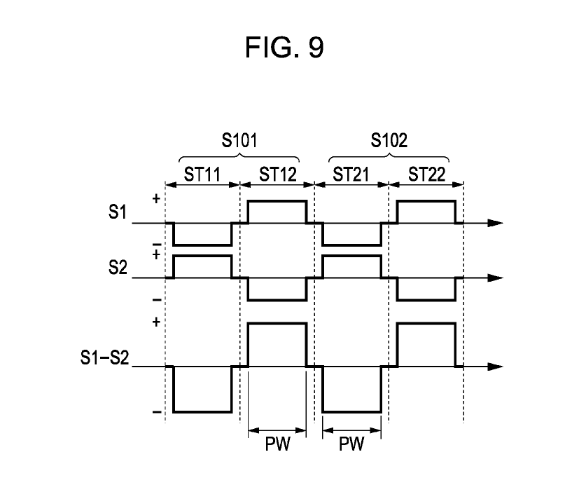

Next, a method of driving an electrophoretic display device of the present embodiment will be described with reference to FIGS. 8A, 8B and 9.

FIGS. 8A and 8B are plane views of the display portion used in the explanation of the driving method of the present embodiment. FIG. 9 is a timing chart in the driving method of the present embodiment. In addition, in FIGS. 8A and 8B, in order to simplify the description, the display portion 5 is shown as a configuration of three pixels×three pixels.

As shown in FIG. 9, the driving method of the present embodiment includes a first image display process S101 that displays a first image on the display portion 5, and a second image display process S102 that displays a second image on the display portion 5. In addition, the first image display process S101 includes a reset waveform input process ST11 and an image signal input process ST12, and the second image display process S102 includes a reset waveform input process ST21 and an image signal input process ST22.

Herein, FIG. 8A shows the display portion 5 in the state in which the first image is written by the first image display process S101, and FIG. 8B shows the display portion 5 in the state in which the second image is written by the second image display process S102. That is, in the present embodiment, the first image is identical to the second image.

Furthermore, in FIGS. 8A, 8B and 9, the electric potential S1 is the electric potential of the data line 68 connected to the central second row of pixel 40, and the electric potential S2 is the electric potential of the data line 68 connected to a right third row of pixel 40 in FIGS. 8A and 8B.

The driving method according to the invention has the reset waveform input process ST11 (ST21) before the image signal input process ST12 (ST22) that displays the image on the display portion 5. Moreover, the reset waveform input process ST11 (ST21) (A) can function so as to reset the current hysteresis due to the display operation of the prior image (an image of the prior frame), and (B) can function so as to reset the current hysteresis due to the display operation of the present image (an image of the present frame).

In the present embodiment, firstly, (A) a case where the current hysteresis due to the display operation of the prior image is reset will be described.

In the driving method (A), the reset waveform input process ST11 of the first image display process S101 resets the current hysteresis due to the display operation in the frame immediately before the first image display process S101, and the description thereof will be omitted.

Next, in the image signal input process ST12, the electric potential S1 (the electric potential of the second row of data line 68) becomes the positive polarity (e.g., 15V), and the electric potential S2 (the electric potential of the third row of data line 68) becomes the negative polarity (e.g., −15V). As a result, the electric potential having the positive polarity is input to the pixel electrode 35 of the pixel 40 belonging to the second row, and the electric potential having the negative polarity is input to the pixel electrode 35 of the pixel 40 belonging to the third row. The standard electric potential (e.g., 0V) is input to the common electrode 37.

As a result, the second row of pixel 40 is displayed in black (see FIG. 3C) and the third row of pixel 40 is displayed in white. As a consequence, as shown in FIG. 8A, the first image having black and white stripes is displayed on the display portion 5.

Moreover, as shown in FIG. 9, in the image signal input process ST12, the electric potential difference S1−S2 of the adjacent data lines 68 (the second and third rows) have the positive polarity (e.g., 30V), and the application period thereof is a pulse width PW.

Next, upon shifting to the second image display process S102, firstly, the reset waveform input process ST21 is executed. In the reset waveform input process ST21, the electric potential S1 becomes the negative polarity (e.g., −15V) and the electric potential S2 becomes the positive polarity (e.g., 15V).

That is, the image signal input in the reset waveform input process ST21 of the second image display process S102 has the opposite polarity to the image signal input in the image signal input process ST12 of the first image display process S101; on the other hand, the pulse having the same amplitude is input to the pixel electrode 35. Furthermore, the pulse width PW of the pulse to be input in the reset waveform input process ST21 is the same as the pulse width PW of the pulse input in the image signal input process ST12. Thus, the electric potential difference S1−S2 between the adjacent data lines 68 in the reset waveform input process ST21 is the negative polarity (e.g., −30V), and the application period thereof is the pulse width PW.

In this manner, in the reset waveform input process ST21, the electric power (the multiplication of the application voltage and the application time) is applied between the adjacent data lines 68 so that the sum of the multiplication of the application voltage and the application time in the immediately preceding image signal input process ST12 becomes zero. As a result, it is possible to reset the hysteresis of the current, which flows from the connection terminal 115 connected to the second row of data line 68 to the connection terminals 115 connected to the third row of data line 68 via the ACP or the like in the image signal input process ST12, by causing the equivalent current to flow in the reverse direction in the reset waveform input process ST21.

In addition, by the reset waveform input process ST21, the second row of pixel 40 is displayed in white and the third row of pixel 40 is displayed in black. That is, the image in which black and white of the first image is reversed is displayed on the display portion 5.

When the reset waveform input process ST21 is finished, the process is shifted to the image signal input process ST22, the electric potential S1 becomes the positive polarity (e.g., 15V), and the electric potential S2 becomes the negative polarity (e.g., −15V). As a result, the second image is displayed on the display portion 5.

As described above, according to the method of driving the electrophoretic display device of the present embodiment, in the reset waveform input process ST21 of the second image display process S102, it is possible to offset the current hysteresis in the immediately preceding image signal input process ST12 to maintain the equilibrium state of the current. As a result, even when the same image is repeatedly displayed, it is possible to effectively prevent corrosion of the connection terminals 115 or the like due to the high voltage to be applied between the adjacent data lines 68, whereby excellent reliability can be obtained over a long period of time.

Furthermore, in the reset waveform input process ST21 of the present embodiment, the pulse (the pulse having the opposite polarity and the same amplitude and pulse width) in which the input pulse of the image signal input process ST12 is reversed is input, but the pulse input in the reset waveform input process ST21 can add an arbitrary change, if it is the pulse in which the absolute value of the multiplication of the pulse and the voltage and the application time become identical. For example, the amplitude of the pulse input in the reset waveform input process ST21 may be set as double and the pulse width may be set as ½ times.

Furthermore, in the above-mentioned embodiment, in order to simplify the description, the description has been given using the image in which all of the second row of pixel 40 are displayed in black and all of the third row of pixel 40 are displayed in white, but, even in the case of more complicated image, the same working effect can be obtained by using the above-mentioned driving method.

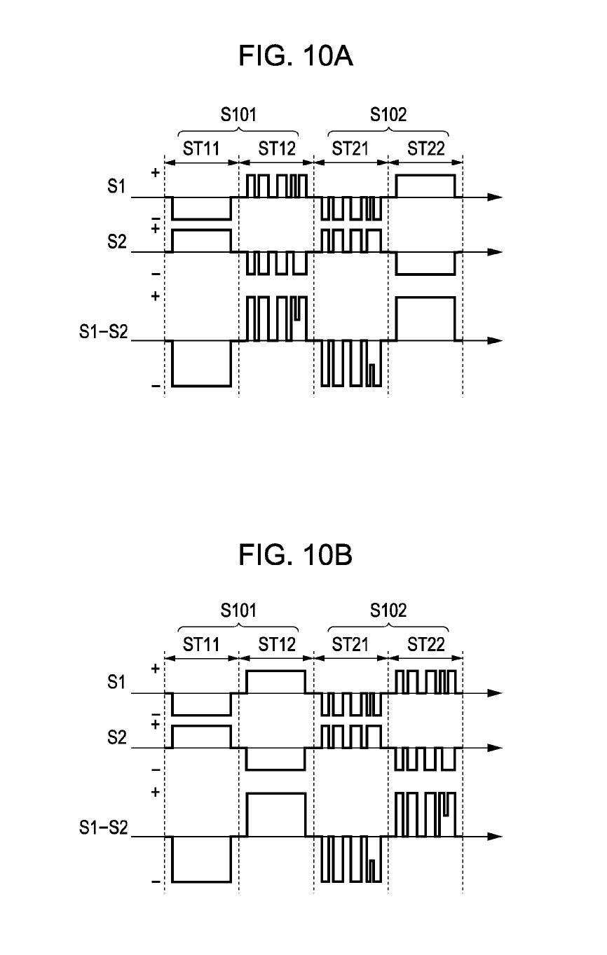

FIG. 10A is a timing chart of a case where the different gradations are displayed in a plurality of pixels 40 belonging to one data line 68. As shown in FIG. 10A, in the image signal input process ST12, the electric potential S1 is changed between the positive polarity electric potential and the standard electric potential depending on the display gradation of the pixel 40 of the written timing. Moreover, the electric potential S2 is changed between the negative polarity electric potential and the standard electric potential depending on the display gradation of the pixel 40 of the written timing.

When the first image is written in the image signal input process ST12, in the reset waveform input process ST21 of the second image display process S102, as shown in FIG. 10A, the waveform in which the polarity of the input waveform of the image signal input process ST12 is reversed is input.

Thus, the pixel electrode 35, which becomes the positive polarity in the image signal input process ST12, becomes the negative polarity in the reset waveform input process ST21, and the pixel electrode 35, which becomes the negative polarity in the image signal input process ST12, becomes the positive polarity in the reset waveform input process ST21.

As a result, the waveform of the electric potential difference S1−S2 in the reset waveform input process ST21 becomes the same as that in which the polarity of the waveform of the electric potential difference S1−S2 in the image signal input process ST12 is reversed, and the current hysteresis is reset by the reset waveform input process ST21 in the same manner as the prior embodiment, whereby the equilibrium state of the current is maintained.

Next, FIG. 10B is (B) a timing chart in a case where the current hysteresis due to the display operation of the image (the image of the frame) is reset by the reset waveform input process.

In the driving method (B) shown in FIG. 10B, in the reset waveform input process ST11 of the first image display process S101, the electric potential S1 becomes the negative polarity and the electric potential S2 becomes the positive polarity, and in the succeeding image signal input process ST12, the electric potential ST12 becomes the positive polarity and the electric potential S2 becomes the negative polarity. That is, the waveform which is input in the reset waveform input process ST11 is the waveform in which the polarity of the waveform to be input in the image signal input process ST12 is reversed.

This is also true for a case where the gradations are different for each pixel 40 as in the second image display process S102, and the waveform which is input in the reset waveform input process ST21 is the waveform in which the polarity waveform to be input in the image signal input process ST22 is reversed.

In the above-mentioned driving method (B), as shown in FIG. 10B, the waveform of the electric potential difference S1−S2 in the reset waveform input process ST11 becomes equivalent to that of the polarity of the waveform of the electric potential difference S1−S2 in the succeeding image signal input process ST12. Thus, the equilibrium state of the current in the first image display process S101 is maintained. Furthermore, even in the succeeding second image display process S102, the equilibrium state of the current is similarly maintained within the period of the same process.

Furthermore, in the driving method (B), the image signal (the image signal corresponding to the second image), which is input in the reset waveform input process ST21, is different from the image signal (the image signal corresponding to the first image) which is input in the immediately preceding image signal input process ST12. For that reason, except for a case where the first image is the same as the second image, the image in which the image components of the first image and the second image are mixed with each other is displayed on the display portion 5 of the reset waveform input process ST21.

On the other hand, in the driving method (B), since the image data used in one frame is one kind and the image data of the preceding frame does not need to be maintained, this is a simpler driving method than the preceding driving method (A).

### Second Embodiment

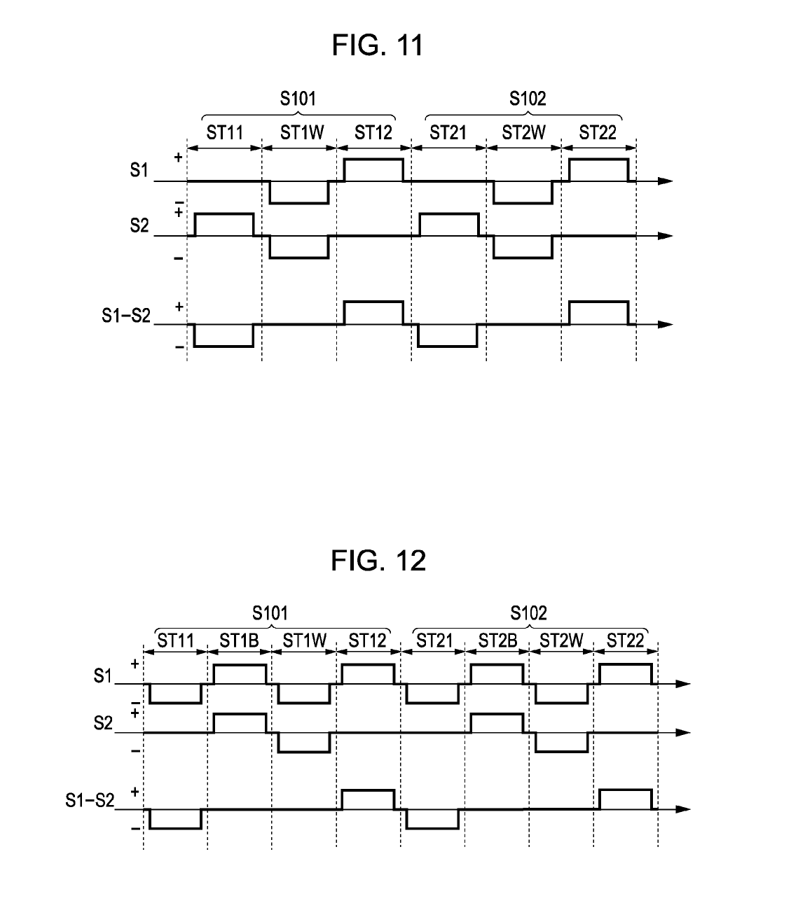

Next, FIG. 11 is a timing chart showing a driving method of a second embodiment of the invention.

The driving method according to the second embodiment includes the first image display process S101 and the second image display process S102, as shown in FIG. 11. Moreover, the first image display process S101 includes the reset waveform input process ST11, an image erasing process ST1W, and the image signal input process ST12. The second image display process S102 includes the reset waveform input process ST21, an image erasing process ST2W, and the image signal input process ST22.

In the present embodiment, the image which is displayed on the display portion 5 in the first image display process S101 and the second image display process S102 is the same as the first image and the second image relating to the preceding embodiment shown in FIGS. 8A and 8B. That is, the image is such that the second row of pixel 40 are displayed in black and the third row of pixel 40 are displayed in white in FIGS. 8A and 8B.

In the driving method of the present embodiment, the display portion 5 is displayed as completely black in the reset waveform input process ST11 (ST21), the display portion 5 is displayed as completely white in the succeeding image erasing process ST1W (ST2W), and the first image (the second image) is displayed on the displayed portion 5 in the next image signal input process ST12 (ST22).

That is, in the reset waveform input process ST21, the waveform is input to the pixel electrode 35 so as to align the entire display portion 5 to the single optical state. Furthermore, in the image erasing process ST2W, the waveform is input to the pixel electrode 35 so as to align all of the pixels of the display portion 5 to the same optical state. Hereinafter, this will be specifically described.

Firstly, in the image signal input process ST12 of the first image display process S101, the electric potential S1 becomes the positive polarity and the electric potential S2 becomes the standard electric potential, and thus, only the pixel 40 connected to the data line 68 (the second row of FIGS. 8A and 8B) supplied with the electric potential S1 is selectively operated in the black display. As a result, the black display area of one pixel width extending in the transverse direction shown in FIGS. 8A and 8B is formed on the display portion 5 that is displayed completely in white by the image erasing process ST1W, whereby the first image is displayed as a whole.

Next, in the reset waveform input process ST21 of the second image display process S102, the electric potential S1 becomes the standard electric potential and the electric potential S2 become the positive polarity. Then, in the state in which the display of the pixel 40 supplied with the electric potential S1 is not changed, only the pixel 40 supplied with the electric potential S2 is selectively operated in the black display, and the overall display portion 5 is displayed in black. That is, in the reset waveform input process ST21, the pixel 40 which were not driven in the immediately preceding image signal input process ST12 are selectively driven.

Thereafter, in the image erasing process ST2W, the electric potential S1 becomes the negative polarity, and the electric potential S2 becomes the negative polarity. That is, in the image erasing process ST2W, all of the pixels are provided with the negative polarities and operated in the completely white display.

According to the above-mentioned operation, as shown in FIG. 11, the waveform of the electric potential difference S1−S2 in the reset waveform input process ST21 becomes equivalent to that the polarity of the waveform of the electric potential difference S1−S2 in the immediately preceding image signal input process ST12 is reversed. As a result, the current hysteresis of the image signal input process ST12 can be reset by the reset waveform input process ST21, which makes it possible to maintain the equilibrium state of the current.

Moreover, unlike the above-mentioned operation, in the reset waveform input process ST21, even in a case where the pixel 40 driven in the immediately preceding image signal input process ST12 are selectively operated in the white display and the overall display portion 5 is aligned in the white display, the waveform of the electric potential difference S1−S2 in the reset waveform input process ST21 becomes equivalent to that the polarity of the waveform of the electric potential difference S1−S2 in the immediately preceding image signal input process ST12 is reversed. As a result, the current hysteresis of the image signal input process ST12 can be reset by the reset waveform input process ST21, which makes possible to maintain the equilibrium state of the current. However, since the equilibrium state of the current collapses in the pixel unit in this case, it is desirable to periodically add the waveform that aligns the current equilibrium state of the pixel unit.

Furthermore, the description has been given of the case of resetting the current hysteresis of the immediately preceding image signal input process ST12 by the reset waveform input process ST21. However, as in the driving method (B) according to the first embodiment shown in FIG. 10B, it is possible to configure such that the reset waveform input process ST21 resets the current hysteresis due to the next image signal input process ST22. That is, the input waveform in the reset waveform input process ST21 may be the input waveform that shifts the image displayed by the image signal input process ST22 to the single gradation (the black display). Even in this case, the above-mentioned working effect can be obtained.

Furthermore, as in the driving method (B) according to the first embodiment, the image signal (the image signal corresponding to the second image) which is input in the reset waveform input process ST21 is different from the image signal (the image signal corresponding to the first image) which is input in the immediately preceding image signal input process ST12. For that reason, except for a case where the first image is the same as the second image, the image in which the image components of the first image and the second image are mixed with each other is displayed on the display portion 5 of the reset waveform input process ST21.

On the other hand, since the image data used in one frame is of one kind and the image data of the preceding frame does not need to be maintained, this method is simpler than the preceding driving method.

According to the second embodiment described above, since the image can be displayed while resetting the current hysteresis due to the image display operation, it is possible to prevent the occurrence of corrosion in the connection terminal 115 or the like, whereby excellent reliability can be obtained over a long period of time.

Furthermore, in the case of the present embodiment, the waveform of only one polarity is input in the reset waveform input process ST11 (ST21) and the image signal input process ST12 (ST22). By performing this operation method, as shown in FIG. 11, the maximum value of the electric potential difference S1−S2 becomes ½ of the electric potential difference S1−S2 in the first embodiment. Thus, it becomes more difficult for the current to flow between the terminals, whereby the occurrence of corrosion can be further effectively suppressed.

Furthermore, the display portion 5 is displayed as completely black in the reset waveform input process ST11 (ST21) and displayed as completely white in the succeeding image erasing process ST1W (ST2W), and then, an arbitrary image is displayed by the image signal input process ST12 (ST22). Thus, no image is displayed in the reset waveform input process as in the first embodiment, and the user does not feel any sense of unease.

### Third Embodiment

Next, FIG. 12 is a timing chart showing a driving method of a third embodiment of the invention.

As shown in FIG. 12, the driving method according to the third embodiment includes the first image display process S101 and the second image display process S102. Furthermore, the first image display process S101 includes the reset waveform input process ST11, a first image erasing process ST1B, a second image erasing process ST1W, and the image signal input process ST12. The second image display process S102 includes the reset waveform input process ST21, a first image erasing process ST2B, a second image erasing process ST2W, and the image signal input process ST22.

In the present embodiment, the image displayed on the display portion 5 in the first image display process S101 and the second image display process S102 is the same as the first image and the second image according to the preceding embodiment shown in FIGS. 8A and 8B. That is, it is the image in which the second row of pixel 40 of FIGS. 8A and 8B are displayed in black and the third row of pixel 40 thereof are displayed in white.

In the driving method of the present embodiment, the display portion 5 is displayed as completely white in the reset waveform input process ST11 (ST21), the display portion 5 is displayed as completely black in the succeeding first image erasing process ST1B (ST2B), and then the display portion 5 is displayed as completely white in the second image erasing process ST1W (ST2W). Next, the first image (the second image) is displayed on the display portion 5 in the image signal input process ST12 (ST22).

That is, in the reset waveform input process ST21, the waveform is input to the pixel electrode 35 so as to align the entire display portion 5 to the single optical state. Furthermore, in the first image erasing process ST2B, the waveform is input to the pixel electrode 35 so as to align all of the pixels of the display portion 5 to the first gradation. Moreover, in the second image erasing process ST2B, the waveform is input to the pixel electrode 35 so as to align all of the pixels of the display portion 5 to the second gradation. Hereinafter, it will be specifically described.

Firstly, in the image signal input process ST12 of the first image display process S101, the electric potential S1 becomes the positive polarity and the electric potential S2 becomes the standard electric potential, and thus, only the pixel 40 connected to the data line 68 (the second row of FIGS. 8A and 8B) which is supplied with the electric potential S1 is selectively operated in the black display. As a result, the black display area of one pixel width extending in the transverse direction shown in FIGS. 8A and 8B is formed on the display portion 5 that is displayed as completely white by the second image erasing process ST1W, whereby the first image is displayed as a whole.

Next, in the reset waveform input process ST21 of the second image display process S102, the electric potential S1 becomes the negative polarity and the electric potential S2 become the standard electric potential. Then, in the state in which the display of the pixel 40 supplied with the electric potential S2 is not changed, only the pixel 40 supplied with the electric potential S1 is selectively operated in the white display, and the overall display portion 5 is displayed in white. That is, in the reset waveform input process ST21 of the present embodiment, the pixel 40 which were operated in the black display in the immediately preceding image signal input process ST12 are selectively operated in the white display, and the display portion 5 is displayed as completely white.

Furthermore, the input waveform in the reset waveform input process ST21 is the waveform that aligns the overall display portion 5 to the single optical state and the waveform in which the polarity of the input waveform of the immediately preceding image signal input process ST12 is reversed.

Thereafter, in the first image erasing process ST2B, the electric potential S1 becomes the positive polarity and the electric potential S2 becomes the positive polarity. That is, in the image erasing process ST2B, all of the pixels are provided with the positive polarities and operated in the completely black display.

Next, in the second image erasing process ST2W, the electric potential S1 becomes the negative polarity and the electric potential S2 becomes the negative polarity. That is, in the image erasing process ST2W, all of the pixels are provided with the negative polarity and operated in the completely white display.

According to the above-mentioned operation, as shown in FIG. 12, the waveform of the electric potential difference S1−S2 in the reset waveform input process ST21 becomes equivalent to that the polarity of the waveform of the electric potential difference S1−S2 in the immediately preceding image signal input process ST12 is reversed. As a result, the current hysteresis of the image signal input process ST12 can be reset by the reset waveform input process ST21, which makes it possible to maintain the equilibrium state of the current.

Furthermore, the description has been given of the case of resetting the current hysteresis of the immediately preceding image signal input process ST12 by the reset waveform input process ST21. However, as in the driving method (B) according to the first embodiment shown in FIG. 10B, it is possible to configure such that the reset waveform input process ST21 resets the current hysteresis due to the next image signal input process ST22. That is, the input waveform in the reset waveform input process ST21 may be the waveform in which the polarity of the input waveform in the image signal input process ST22 is reversed. Even in this case, the above-mentioned working effect can be obtained.

According to the third embodiment described above, since the image can be displayed while resetting the current hysteresis due to the image display operation, it is possible to prevent the occurrence of corrosion in the connection terminal 115 or the like, whereby excellent reliability can be obtained over a long period of time.

Furthermore, even in the case of the present embodiment, the waveform of only one polarity is input in the reset waveform input process ST11 (ST21) and the image signal input process ST12 (ST22). By performing this driving method, as shown in FIG. 12, the maximum value of the electric potential difference S1−S2 becomes ½ of the electric potential difference S1−S2 in the first embodiment. Thus, the current between the terminals has greater difficulty flowing, whereby the occurrence of corrosion can be further effectively suppressed.

Furthermore, the display portion 5 is displayed as completely white in the reset waveform input process ST11 (ST21), displayed as completely black in the first image erasing process ST1B (ST2B), and displayed as completely white in the second image erasing process ST1W (ST2W), and then, an arbitrary image is displayed by the image signal input process ST12 (ST22). Thus, no image is displayed in the reset waveform input process as in the first embodiment, and the user does not feel a sense of unease. Moreover, since the image erasing operations are performed several times, the occurrence of afterimages is suppressed and a high quality of display can be obtained.

### Electronic Equipment

Next, a case where the electrophoretic display device of the above-mentioned embodiment is applied to electronic equipment will be described.

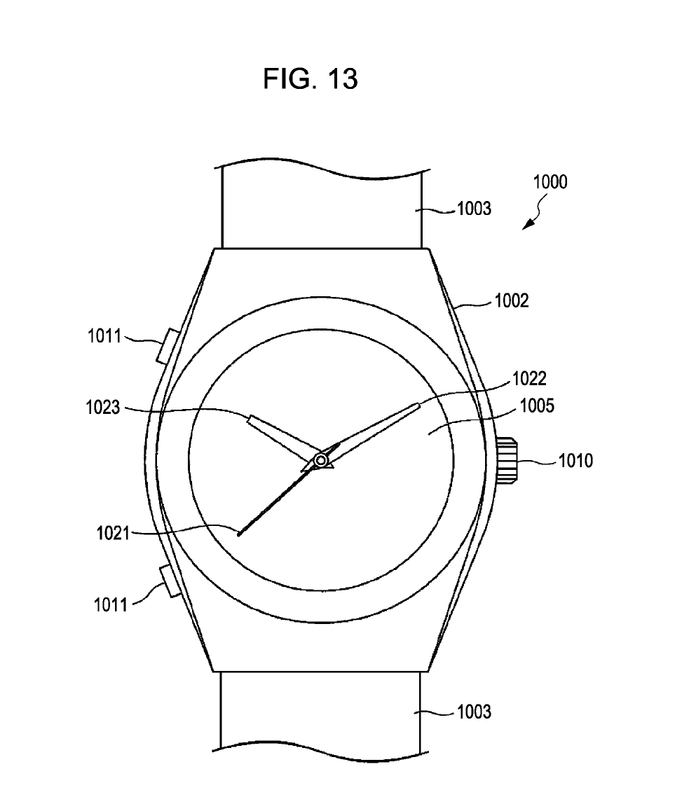

FIG. 13 is a front view of a wrist watch 1000. The wrist watch 1000 includes a watch case 1002 and a pair of bands 1003 connected to the watch case 1002.

At a front of the watch case 1002, a display portion 1005 which is constituted by the electrophoretic display devices of each embodiment, a second hand 1021, a minute hand 1022, and an hour hand 1023 are provided. At a side of the watch case 1002, a stem 1010 and an operation button 1011 as operating control are provided. The stem 1010 is connected to a winder (not shown) provided in the case and integrated with the winder and can be drawn out in multiple stages (e.g., two stages) and is provided so as to be freely rotated. On the display portion 1005, the image becoming the background, a character string such as a date or a time, or the second hand, the minute hand, the hour hand or the like can be displayed.

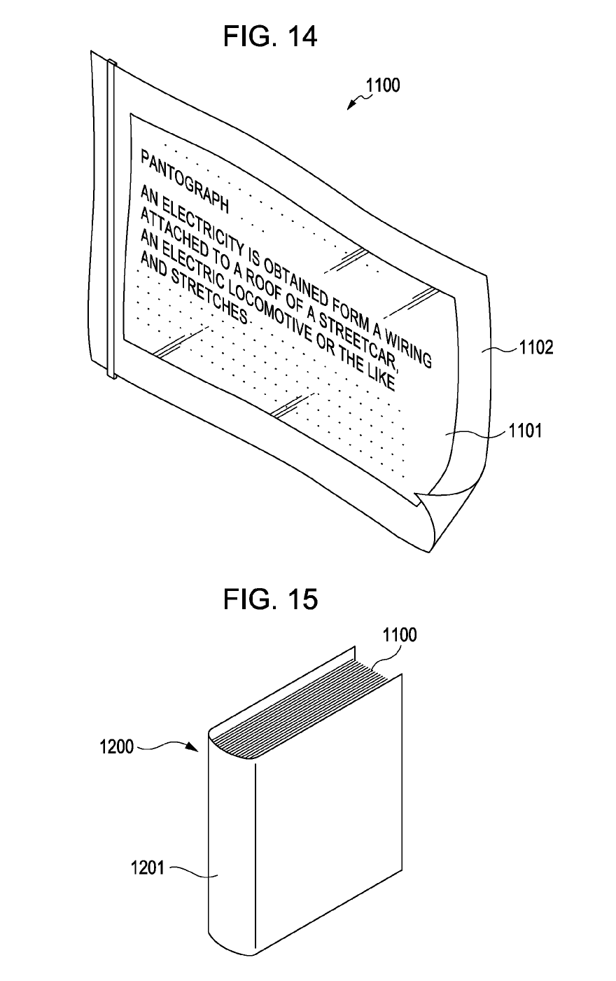

FIG. 14 is a perspective view showing a configuration of an electronic paper 1100. The electronic paper 1100 includes the electrophoretic display device of the above-mentioned embodiment in a display area 1101. The electronic paper 1100 has flexibility, and is configured to include a main body 1102 that is formed of a rewritable sheet having the same texture and pliability as the paper of the related art.

FIG. 15 is a perspective view showing a configuration of an electronic note 1200. The electronic note 1200 is formed such that a plurality of electronic papers 1100 is tied and pinched between covers 1201. For example, the covers 1201 include a display data input unit (not shown) that inputs the display data to be sent from an external device. As a result, it is possible to change or renew the display content depending on the display data, in the state in which the electronic papers are tied.

According to the wrist watch 1000, the electronic paper 1100, and the electronic note 1200 as described above, since the electrophoretic display device relating to the invention is adopted, there is provided electronic equipment including a display unit that has excellent reliability over a long period of time.

Furthermore, the electronic equipment indicates electronic equipment relating to the invention and does not limit the technical scope of the invention. For example, the electro-optical device relating to the invention can be very suitably used even in a display portion of electronic equipment, for example, a mobile phone and portable audio equipment.

The entire disclosure of Japanese Patent Application No. 2009-279838, filed Dec. 9, 2009 is expressly incorporated by reference herein.

What is claimed is:

1. A method of driving an electrophoretic display device including a pair of substrates, an electrophoretic element disposed between the pair of substrates, and a display portion with a plurality of pixels arranged thereon, each pixel having an electrode in which an image signal is input, comprising:
a reset waveform input process in which, when a display image of the display portion is renewed from a first image to a second image, after displaying the first image and before displaying the second image, a prescribed image signal corresponding to an image different from the second image is input to the electrode.

2. A method of driving an electrophoretic display device according to claim 1,
wherein the prescribed image signal is a reversal image signal which is an image signal obtained by reversing the polarity of the image signal corresponding to the first image.

3. A method of driving an electrophoretic display device according to claim 1,
wherein the prescribed image signal is a reversal image signal which is an image signal obtained by reversing the polarity of the image signal corresponding to the second image.

4. A method of driving an electrophoretic display device according to claim 1,
wherein the prescribed image signal is an image signal that shifts the display portion to a single gradation.

5. A method of driving an electrophoretic display device according to claim 1,
wherein the prescribed image signal is an image signal which shifts the display portion of the time when the second image is displayed to a single gradation.

6. The method of driving the electrophoretic display device according to claim 1, further comprising:
an image erasing process of shifting all the pixels of the display portion to the same gradation after the reset waveform input process and before displaying the image on the display portion.

7. The method of driving the electrophoretic display device according to claim 6,
wherein the image erasing process includes a first image erasing process of shifting all the pixels of the display portion to a first gradation and a second image erasing process of shifting all the pixels to a second gradation.

8. An electrophoretic display device including a pair of substrates, an electrophoretic element disposed between the pair of substrates, a display portion with a plurality of pixels arranged thereon, each pixel having an electrode in which an image signal is input, and a control portion that drives and controls the pixel, comprising:
wherein, when a display image of the display portion is renewed from a first image to a second image, after displaying the first image and before displaying the second image, the control portion executes a reset waveform input operation of inputting a prescribed image signal corresponding to an image different from the second image to the electrode.

9. An electrophoretic display device according to claim 8,
wherein the prescribed image signal is a reversal image signal which is an image signal obtained by reversing the polarity of the image signal corresponding to the first image.

10. An electrophoretic display device according to claim 8,
wherein the prescribed image signal is a reversal image signal which is an image signal obtained by reversing the polarity of the image signal corresponding to the second image.

11. An electrophoretic display device according to claim 8,
wherein the prescribed image signal is an image signal that shifts the display portion to a single gradation.

12. An electrophoretic display device according to claim 8,
wherein the prescribed image signal is an image signal which shifts the display portion of the time when the second image is displayed to a single gradation.

13. The electrophoretic display device according to claim 8,
wherein the control portion executes an image erasing operation of shifting all the pixels to the same gradation after the reset waveform input operation and before the operation of displaying the image on the display portion.

14. The electrophoretic display device according to claim 13,
wherein the image erasing operation includes a first image erasing operation of shifting all the pixels of the display portion to a first gradation, and a second image erasing operation of shifting all the pixels to a second gradation.

15. Electronic equipment including the electrophoretic display device according to claim 8.

16. Electronic equipment including the electrophoretic display device according to claim 9.

17. Electronic equipment including the electrophoretic display device according to claim 10.

18. Electronic equipment including the electrophoretic display device according to claim 11.

19. Electronic equipment including the electrophoretic display device according to claim 12.

20. Electronic equipment including the electrophoretic display device according to claim 13.
